(19) United States
(12) Patent Application Publication
(10) Pub. No.: US 2009/0300527 A1
(43) Pub. Date: Dec. 3, 2009

(54) USER INTERFACE FOR BULK OPERATIONS ON DOCUMENTS

(75) Inventors: Jason L. Malcolm, Kent, WA (US); Patrick J. Baumgartner, Kirkland, WA (US); Luming Wang, Bellevue, WA (US); Xiaohong Yang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/131,678

(22) Filed: Jun. 2, 2008

(51) Int. Cl. G06F 3/048

(52) U.S. Cl. 715/764

(57) ABSTRACT

A user interface displays a group of related documents such that bulk operations may be performed on them without requiring the user to individually access each document to perform an action. Properties, such as a status, contributor information, submission date and submission deadline and the like are also displayed with the documents. From this information, a user may decide to open a specific document and/or version of the document for review while bulk approving the other displayed documents. A user may perform an action on all or part of the displayed documents and their versions from the user interface. In this way, the efficiency of the workflow may be increased since the user doesn't have to individually access each document to perform the action.

### BACKGROUND

A workflow defines a series of tasks within an organization to produce a final outcome. Workflows allow for business process formalization and management. A workgroup computing application allows different workflows to be defined for different types of jobs. For example, in a publishing setting, a document may be automatically routed from writers to editors to proofreaders to production. At each stage in the workflow, an individual or group is responsible for a specific task. Once the task is complete, the workflow software helps to ensure that the individuals responsible for reviewing and/or approving a task is notified. Individuals that are responsible for reviewing items within a workflow are often presented with multiple versions and workflow stages of documents. It is not uncommon that a single user performs a workflow action (such as review, approve, discard, change status) many times within a workflow.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A user interface displays a group of related documents such that bulk operations may be performed on them without requiring the user to individually access each document to perform an action. Properties, such as a status, contributor information, submission date and submission deadline and the like are also displayed with the documents. From this information, a user may decide to open a specific document and/or version of the document for review while bulk approving the other displayed documents. A user may perform an action on all or part of the displayed documents and their versions from the user interface. In this way, the efficiency of the workflow may be increased since the user doesn't have to individually access each document to perform the action.

### BRIEF DESCRIPTION OF THE DRAWINGS

FIG. 1 illustrates an exemplary computing device;

FIG. 2 shows a bulk operation user interface system;

FIGS. 3 and 4 illustrate exemplary bulk operation user interfaces; and

FIG. 5 shows an illustrative process for bulk operations on related documents.

### DETAILED DESCRIPTION

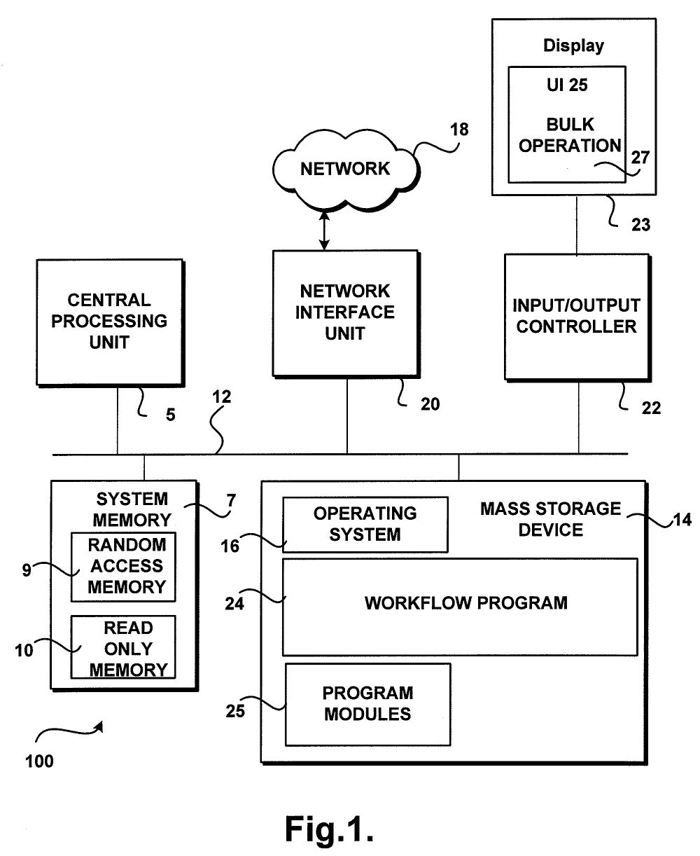

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, a workflow program 24, and other program modules 25, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 23 including bulk operations user interface (UI) 25, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS® VISTA® operating system from MICROSOFT® CORPORATION of Redmond, Wash. The mass storage device 14 and RAM 9 may also store one or more program modules. In particular, the mass storage device 14 and the RAM 9 may store one or more application programs, such as a workflow application 24. The workflow application 24 displays a bulk operations command surface 27 through User Interface (“UI”) 25 on display 23. For example, workflow application could be an application, such as Microsoft Office SharePoint Designer 2007®. Generally, the workflow application 24 enables users to participate in a workflow by handling their designated tasks. For example, one or more users may be assigned the role of reviewing/approving submitted documents. In many scenarios, a designated user may be presented with hundreds of documents (including different versions of the same document) to review/approve. In order to help alleviate this burden on the user, related documents are displayed within bulk operation user interface 27 such that bulk operations may be performed on them without requiring the user to individually access each document to perform an action. Properties, such as a status, contributor information, submission date and submission deadline and the like are also displayed with the documents. From this information, a user may decide to open a specific document and/or version of the document for review while bulk approving the other displayed documents. A user may perform an action on all or part of the displayed documents and their versions from the user interface. In this way, the efficiency of the workflow may be increased since the user doesn't have to individually access each document to perform the action. Additional details regarding the workflow bulk command interface will be provided below.

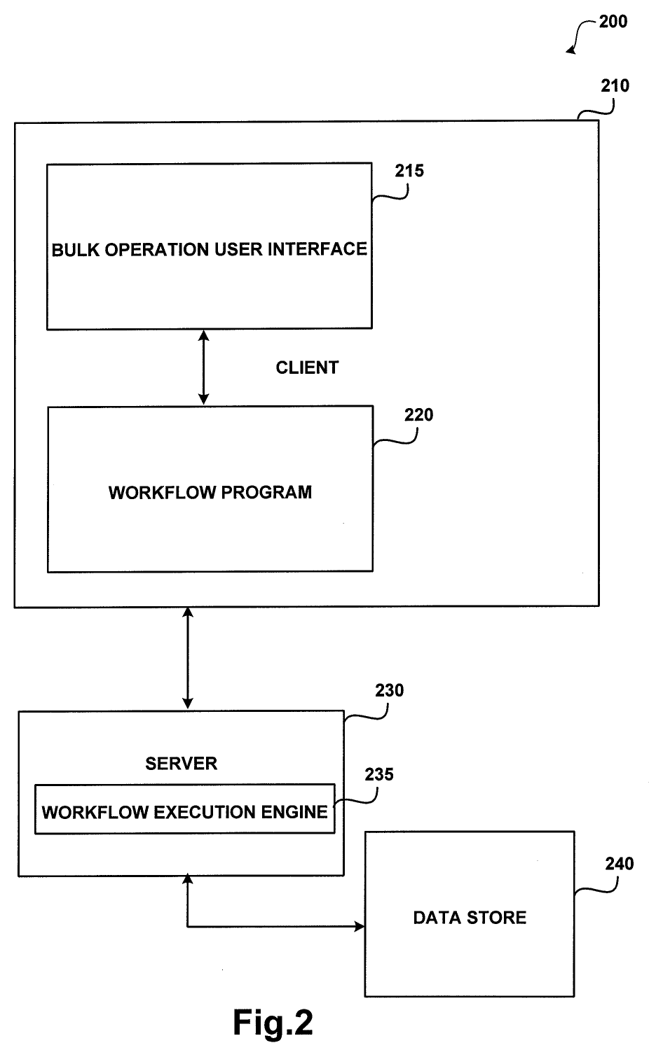

FIG. 2 shows a bulk operation user interface system. The system 200 includes a client 210 for user access, a server 230, and data store 240. Client 210 and data store 240 are each coupled to server 230. Client 210 includes workflow program 220 and bulk approval user interface 210. Server 230 includes workflow execution engine 235.

Data store 240 is configured to store data relating to the execution of a workflow. For example, data store 240 may be configured to store documents, data relating to the review of documents, document templates, workflow schedules, and the like. Workflow templates contain one or more workflow schedules, which contain activities that represent actions to perform.

Workflow program 220 is utilized by a client to process workflows. Workflows may be configured for many different items. According to one embodiment, the workflows relate to the approval/review of documents. Workflows that include user interaction are inherently long running. In many scenarios, workflows will typically take days, if not longer, to complete. Consider the example workflow that routes documents and their different versions for approval. It may take several days for the approver to get to the task of reviewing the document and its versions. When end-users are part of a workflow they are often presented with multiple versions and workflow stages of documents. It is not uncommon that a single user will need to perform a workflow action (such as review, approve, discard, change status) on many different versions of a document. This can be exacerbated when the reviewer is faced with reviewing tens or hundreds of documents and their revisions.

Bulk operation user interface 215 is directed at reducing the time it takes to review/approve documents. Interface 215 displays a group of related documents together in the display such that bulk operations may be performed on more than one of the displayed documents without requiring the user to individually access each document to perform the action. As such, the user does not have to individually cycle through each document and/or version to complete their assigned review task within the workflow.

As the workflow runs and tasks are created, the user can select the task, mark it as completed for more than one document that is selected within bulk operation user interface 215, and enter any optional or required information specific to the workflow. The workflow instance is then notified of changes to workflow tasks, and can choose to respond to those changes as specified in the workflow. This workflow response can include moving the item to another stage of the workflow.

Workflow execution engine 226 manages execution of the workflow. For example, workflow execution engine may manage a workflow by reordering a sequence of steps or by changing a sequence of steps to execute in parallel or serially. The workflow engine provides the services that workflow application 220 needs, such as sequencing, state management, tracking capabilities, and transaction support. The workflow engine serves as a state machine responsible for loading and unloading workflow templates, as well as managing the current state of any workflows that are running. Workflow execution engine 235 may instruct workflow program 220 of the related documents to display within user interface 215.

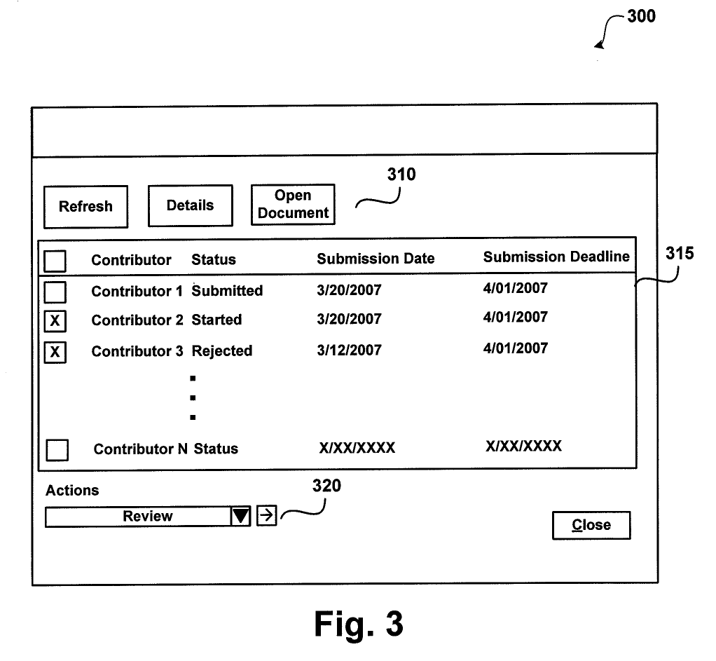

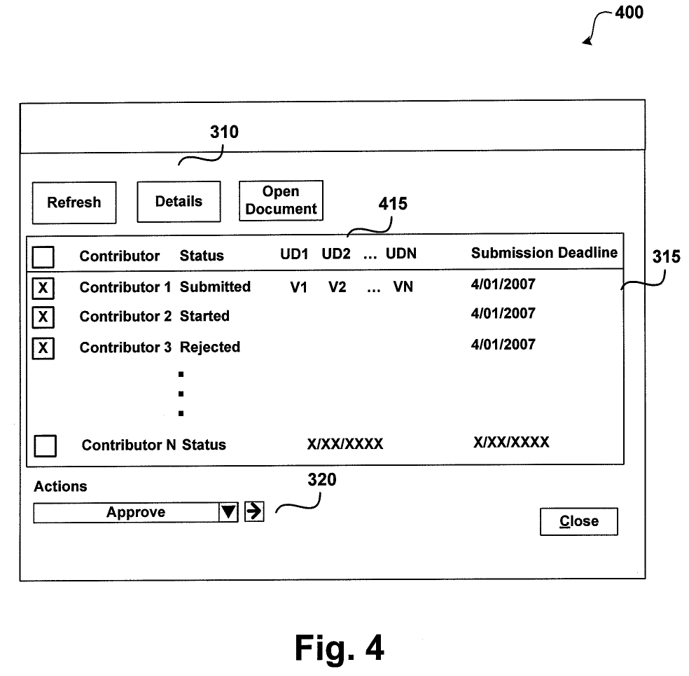

FIGS. 3 and 4 illustrate exemplary bulk operation user interfaces. Referring to FIG. 3, user interface 300 includes command area 310, document area 315, and selectable action area 320.

Document area 315 displays a collection of document versions. When end-users are part of a workflow they are often presented with multiple versions and workflow stages of documents. It is not uncommon that a single user will need to perform a workflow action (such as review, approve, discard, change status) on many different versions of a document. As such, document area 315 could include hundreds (or more or less) of related documents. Document area 315 includes a listing of the documents that are selectable by a user to perform an action on. In this way, a user can perform multiple workflow actions on a collection of document versions by selecting the documents to perform the action upon. As illustrated, user interface 300 simultaneously displays all the document versions and their status to a user who has been assigned to perform an action (such as reviewing, approving) on multiple versions of a document at the same time. Document area 315 includes a selectable box from which a user may select one or more of the documents to perform an action. An action is applied to each one of the documents that is selected. As illustrated, each document that is displayed also includes property information relating to that document. According to one embodiment, the properties include the contributor, the status of the document, the submission date and the submission deadline. Other properties may also be included. For example, any work flow property may be displayed. For example, referring to FIG. 4, the user is provided with user interface 400 that displays other defined properties UD1-UDN (415). According to one embodiment, the user selects these properties from the properties that are available with the documents. According to another embodiment, these other properties may be pre-selected and included within interface 400. FIG. 4 illustrates that other properties and information may be included within a bulk operations user interface.

Command area 310 includes commands that are commonly used when performing an action on a document. According to one embodiment, the commands include a refresh command, a details command and an open document command. The refresh command refreshes the document list that is displayed in document area 315. The details command provides additional details associated with the selected document(s). For example, selecting the details button may provide more properties that are associated with the selected documents. The open document command opens the selected documents for review.

Action area 320 includes a selectable list of commands that are available to be applied to the document (i.e. review, approve, discard, change status, and the like). When the user applies the selected action, the selected action is applied to each of the selected documents within document area 315. In this way, a user does not have to manually go through each and every document, which can be a very tedious task.

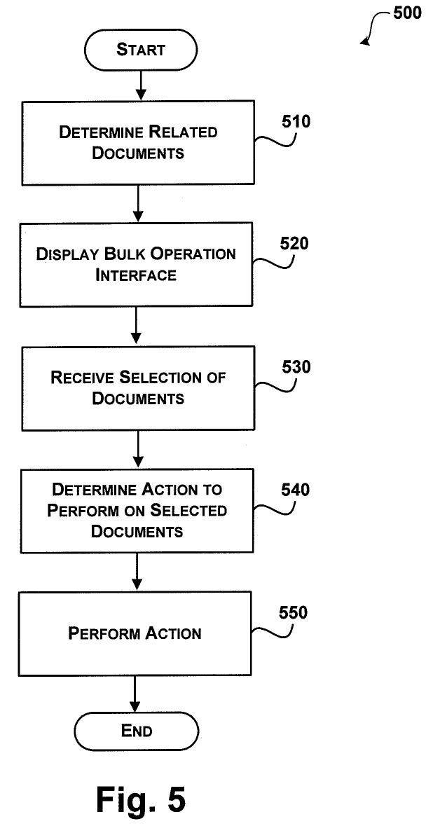

Referring now to FIG. 5, an illustrative process for bulk operations on related documents will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 500, where the documents to display within the bulk operations user interface are determined. According to one embodiment, the related documents include each version of a document that is to be acted on by a user within a workflow. The user may be assigned to review/approve or perform some other action on a document and its versions. The related documents may be determined by the workflow program based on the workflow schedule or some other methodology.

Flowing to operation 520, the related documents are displayed in the bulk operations user interface. The bulk interface could display hundreds (or more or less) of related documents. The displayed interface also includes a display of properties related to the documents. For example, the displayed properties may include the contributor, the status of the document, the submission date and the submission deadline. Other properties may also be displayed. Each document that is displayed is selectable by a user such that the user may select one or more of the documents to perform an action.

Moving to operation 530, a determination is made as to what documents have been selected by a user. The selection may include all or a portion of the documents.

Transitioning to operation 540, the action to perform on the selected documents is determined. The action to be performed relates to an action that s appropriate for the workflow. For instance, the action could be to open the documents, view more or less properties relating to the documents, review the documents, approve the documents, delete the documents, change a status of the documents, and the like.

Moving to operation 550, the action to be performed on the documents is executed. In this way, the efficiency of the workflow may be increased since the user doesn't have to individually access each document to perform the action. The process then moves to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for applying an action to more than one document associated with a workflow, comprising:
displaying documents within a user interface of a workflow application; wherein the documents displayed within the user interface are associated with a user who is assigned to perform an action on each of the documents;
determining a selection of documents within the user interface;
determining an action to perform on the selected documents; and
performing the action on the selected documents using the workflow application.

2. The computer-implemented method of claim 1, further comprising determining the documents to display by determining related documents; wherein related documents include different versions of the same document that require an action to be performed on each of the documents.

3. The computer-implemented method of claim 2, further comprising displaying properties with each of the displayed documents; wherein the properties include a contributor and a status of the document within the workflow.

4. The computer-implemented method of claim 2, wherein the properties to display are selectable by the user.

5. The computer-implemented method of claim 2, wherein the action to performed on the documents is selected from a set of actions including approving, reviewing and opening the selected documents.

6. The computer-implemented method of claim 5, wherein the set of actions further comprises changing a status and discarding the selected documents.

7. The computer-implemented method of claim 3, wherein the user interface includes a command area that includes a refresh command to update the displayed list of documents; a open command to open selected documents and a details command that provides additional details regarding the selected documents.

8. The computer-implemented method of claim 7, wherein the user interface includes a second command area that includes a list of selectable actions to perform on the selected documents.

9. A computer-readable medium having computer-executable instructions for applying an action to more than one document associated with a workflow, comprising:
displaying documents within a user interface of a workflow application; wherein the documents displayed within the user interface are associated with a user who is assigned to perform an action on each of the documents;
determining when an action is to be performed on a selection of documents within the user interface; and
performing the action on the selected documents.

10. The computer-readable medium of claim 9, further comprising determining the documents to display by determining each version of the same document that requires an action to be performed on each of the documents by the user.

11. The computer-readable medium of claim 10, further comprising displaying a contributor property, a workflow status property, a submission date property, and a submission deadline property with each of the displayed documents.

12. The computer-readable medium method of claim 10, wherein the properties to display are selected by the user from a list of available properties that are associated with each of the displayed documents.

13. The computer-readable medium of claim 10, wherein the action to performed on the documents is selected from a set of actions including approving an rejecting the selected documents.

14. The computer-readable medium of claim 13, wherein the set of actions further comprises changing a workflow status of the selected documents.

15. The computer-readable medium of claim 11, wherein the user interface includes displaying a command area that includes a refresh command to update the displayed list of documents; a open command to open selected documents and a details command that provides additional details regarding the selected documents.

16. The computer-readable medium of claim 15, wherein the user interface includes displaying a second command area that includes a list of selectable actions to perform on the selected documents.

17. A system for applying an action to more than one document associated with a workflow, comprising:
a processor and a computer-readable medium;
an operating environment stored on the computer-readable medium and executing on the processor;
a display configured to display a bulk operations user interface; and
a workflow application operating under the control of the operating environment and operative to:
displaying documents within the bulk operations user interface of a workflow application; wherein the documents displayed within the user interface are associated with a user who is assigned to perform an action on each of the documents and wherein the documents are related to each other within the workflow;
determining a selection of documents within the user interface;
determining an action to perform on the selected documents;
and
performing the action on the selected documents using the workflow application.

18. The system of claim 17, further comprising displaying properties with each of the displayed documents; wherein the properties include a contributor and a status of the document within the workflow and wherein the properties displayed are configurable by the user.

19. The system of claim 17, wherein the action to performed on the documents is selected from a set of actions including approving, reviewing, rejecting and opening the selected documents.

20. The system of claim 17, wherein the bulk operations user interface includes a refresh command to update the displayed list of documents; a open command to open selected documents and a details command that provides additional details regarding the selected documents and also includes a second command area that includes a list of selectable actions to perform on the selected documents.
